(19) United States
(12) Patent Application Publication
(10) Pub. No.: US 2024/0108526 A1
(43) Pub. Date: Apr. 4, 2024

(54) MASSAGE APPARATUS HAVING ROTATABLE ARM MASSAGE UNIT

(71) Applicant: BODYFRIEND CO., LTD., Seoul (KR)

(72) Inventors: Beom Seok LEE, Seoul (KR); Gi Won UM, Seoul (KR)

(21) Appl. No.: 18/242,160

(22) Filed: Sep. 5, 2023

(30) Foreign Application Priority Data
Sep. 30, 2022 (KR) 10-2022-0125685
Dec. 12, 2022 (KR) 10-2022-0172662
Jul. 14, 2023 (KR) 10-2023-0091668

(51) Int. Cl. A61G 15/12; A61G 15/00; A61G 15/02; A61H 15/00

(52) U.S. Cl. CPC A61G 15/12; A61G 15/007; A61G 15/02; A61H 15/00; A61H 2201/0149; A61H 2201/1638; A61H 2201/1669; A61H 2205/06

(57) ABSTRACT

Provided is a massage device which can provide various massage functions and stretching functions to the user's arm by linearly moving an arm massage unit in conjunction with a rotational action when the arm massage unit rotates. The massage device includes: a body massage unit including a main frame forming the skeleton of the massage device, and massaging a user's body; arm massage units respectively arranged on both sides of the body massage unit, accommodating both arms of the user, and configured on the body massage unit to rotate around a rotational shaft; a rotation module for rotating the arm massage units in at least one direction; and a position adjustment module operating in conjunction with the rotation action of the arm massage units by the rotation module to allow linear movement of the arm massage units due to the self-weight of the arm massage units.

### CROSS-REFERENCE TO RELATED APPLICATIONS

This application claims the priority to Korean Patent Application Nos. 10-2023-0091668 filed on Jul. 14, 2023, 10-2022-0172662 filed on Dec. 12, 2022, and 10-2022-0125685 filed on Sep. 30, 2022, in the Korean Intellectual Property Office, the disclosures of which are incorporated herein by reference.

### BACKGROUND OF THE INVENTION

### Field of the Invention

The present invention relates to a massage device having a rotatable arm massage unit, and more particularly, to a massage device capable of providing various functions to a user by including a rotatable arm massage unit which massages arm parts of a user.

### Background Art

Massage is a medical assistance therapy for controlling a user's physical modulation, helping blood circulation, and relieving fatigue of the user by applying various types of mechanical stimulation to a portion of the body, such as massaging, pressing, pulling, tapping, or moving a portion of the body of the user.

The growth in a massage demand caused an increase in demand for massage devices or massage devices, which provide an artificial massage function, because of economic feasibility and temporal reasons. That is, as the demand for relieving fatigue or stress is increased while loosening the agglomerated muscles through massage, various mechanical massage devices for time and cost efficiencies are being released.

Recently, there is an increase in interest in health of people, and the massage device is changing as an electronic device providing various additional functions, and/or medical functions from a device simply providing a massage function. Accordingly, researches on how to efficiently control a massage device are continued.

In particular, since users may have different regions to get a massage and may be different in desired stimulation from one another, the demand for apparatuses and methods providing a massage optimized for each user is increasing.

### SUMMARY OF THE INVENTION

Accordingly, the present invention has been made to solve the above-mentioned problems occurring in the prior arts, and it is an object of the present invention to provide a massage device capable of providing various functions to a user by including a rotatable arm massage unit which massages arm parts of a user.

It is another object of the present invention to provide a massage device providing various massage functions and stretching functions to the user's arm by linearly rotating an arm massage unit in link with a rotating action when the arm massage unit is rotated.

The objects of the present invention are not limited to the above-mentioned effects, and other effects, which are not specifically mentioned herein, will be clearly understood by those skilled in the art from the following description.

To accomplish the above object, according to the present invention, there is provided a massage device including: a body massage unit including a main frame forming the skeleton of the massage device, and massaging a user's body; arm massage units respectively arranged on both sides of the body massage unit, accommodating both arms of the user, and configured on the body massage unit to rotate around a rotational shaft; a rotation module for rotating the arm massage units in at least one direction; and a position adjustment module operating in conjunction with the rotation action of the arm massage units by the rotation module to allow linear movement of the arm massage units due to the self-weight of the arm massage units.

According to the present invention, the massage device can provide various functions to a user by including a rotatable arm massage unit.

Furthermore, according to the present invention, the massage device can provide various massage functions and stretching functions to the user's arm by vertically rotating the arm massage unit.

Especially, when the arm massage unit provides various massage and stretching functions while rotating, the present invention allows the arm massage unit to move naturally linearly relative to the rotational axis or the armrest frame of the arm massage unit to move linearly depending on the rotation angle of the arm massage unit, thereby automatically, adjusting the position of the airbag of the arm massage unit to a position suitable for the user.

Accordingly, the massage device according to the present invention enables the user's arm to rotate without being excessively stretched or extended. Therefore, the present invention can prevent arm injuries, prevent the user's arm from slipping out of the arm massage unit, and safely perform arm stretching actions.

Additionally, the massage device according to the present invention can prevent the arm massage unit from sliding excessively by using the cushioning member to enhance durability of the arm massage unit and reduce noise, and can improve accuracy and stability of the movement of the arm massage unit, thereby increasing user satisfaction with the massage device.

In addition, the massage device according to the present invention can shield the space between the lower portion of the arm massage unit and the side of the body massage unit using a side shield provided between the lower portion of the arm massage unit and the side of the body massage unit, thereby preventing an accident where a pet or a child gets caught when the arm massage unit rotates vertically.

The effects of the present invention are not limited to the above-mentioned effects, and other effects, which are not specifically mentioned herein, will be clearly understood by those skilled in the art from the following description.

### BRIEF DESCRIPTION OF THE DRAWINGS

FIG. 1 is a view illustrating a massage device according to an embodiment of the present invention.

FIG. 2 is a view illustrating a main frame of FIG. 1.

FIG. 3 is a view illustrating a detailed configuration of a massage device according to an embodiment of the present invention.

FIG. 4 is a view illustrating external devices which can communicate with the massage device according to an embodiment of the present invention.

FIG. 5 is a view illustrating the entire frame structure of the massage device having the rotatable arm massage unit according to an embodiment of the present invention.

FIG. 6 is a view illustrating a state in which an arm massage unit of the massage device according to an embodiment of the present invention is rotated.

FIG. 7 is a view illustrating a rotation mechanism of the arm massage unit of the massage device according to an embodiment of the present invention.

FIG. 8 is a view illustrating the arm massage unit of the massage device of FIG. 5.

FIG. 9 is an exploded perspective view of a position adjustment module of the arm massage unit of the massage device of FIG. 5.

FIGS. 10A and 10B are views illustrating an operation example of the arm massage unit of the massage device of FIG. 5.

FIG. 11 is a view illustrating a rotation module of the arm massage unit of the massage device of FIG. 5.

FIG. 12 is a view of an arm massage unit of a massage device according to another embodiment of the present invention.

FIGS. 13A and 13B are views illustrating an operation example of the massage device having the arm massage unit of FIG. 12.

FIG. 14 is an exploded perspective view illustrating a configuration of a position adjustment module applied to the arm massage unit illustrated in FIG. 12.

FIG. 15 is a sectional view of the position adjustment module illustrated in FIG. 14.

FIG. 16 is a view illustrating a massage device according to a further embodiment of the present invention.

FIG. 17 is a partial sectional view of the massage device of FIG. 16.

FIG. 18 is a partial sectional view illustrating a modification of the massage device illustrated in FIG. 16.

FIG. 19 is a view illustrating a massage device according to a still further embodiment of the present invention.

FIG. 20 is a view illustrating an operation example of the massage device illustrated in FIG. 19.

FIG. 21 is a side sectional view illustrating a state in which leg massage units of the massage device according to an embodiment of the present invention are rotated individually.

FIG. 22 is a view illustrating a state in which the leg massage units of the massage device according to an embodiment of the present invention are connected to leg connection frames.

### DETAILED DESCRIPTION OF THE PREFERRED EMBODIMENT

The objects, features, and advantages of the present invention described above will become more apparent through the following embodiments in connection with the accompanying drawings.

The following specific structure to functional descriptions are illustrated for the purpose of describing an embodiment according to the concept of the present invention, and embodiments according to the concept of the present invention may be implemented in various forms and should not be construed as being limited to the embodiments described herein or the application.

The embodiments according to the concepts of the present invention may apply various changes and may have various forms, and thus certain embodiments are illustrated in the drawings and will be described in detail in the specification or application. However, it should be understood that the embodiments of the present invention are not intended to limit the embodiments of the present invention to a specific disclosure, and include all modifications, equivalents, and replacements included in the spirit and technical scope of the present invention.

Terms such as first and/or second may be used to describe various components, but the components are not limited to the terms. The terms are only for the purpose of distinguishing one component from other components, for example, without departing from the scope of the present invention, a first component may be referred to as a second component, and similarly, a second component may also be referred to as a first component.

It should be understood that when a component is referred to as being “connected” or “coupled” to another component, it may be directly connected or coupled to the other component, but it should be understood that there may be other components therebetween. On the other hand, when a component is referred to as being “directly connected” or “directly coupled” to another component, it should be understood that there is no other component therebetween. Other expressions for describing the relations between the components, that is, the expression “between” and “directly between” or “adjacent to” and “directly adjacent to” should be interpreted in the same manner.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

In this specification, an actuator means a component capable of providing a driving force. For instance, the actuator may be a motor, a linear motor, an electronic motor, a DC motor, an AC motor, a linear actuator, an electric actuator, or the like, but is not limited thereto.

In this specification, a binaural beat may refer to audio information of a specific form capable of adjusting brainwaves.

In this specification, according to an embodiment, the massage device may include a body massage unit and a leg massage unit. In addition, according to another embodiment, the body massage unit and the leg massage unit may be provided as separate devices (for example, a body massage device and a leg massage device), and the massage device may refer to a body massage device or a leg massage device.

Hereinafter, embodiments of the present invention will be described in more detail with reference to the accompanying drawings.

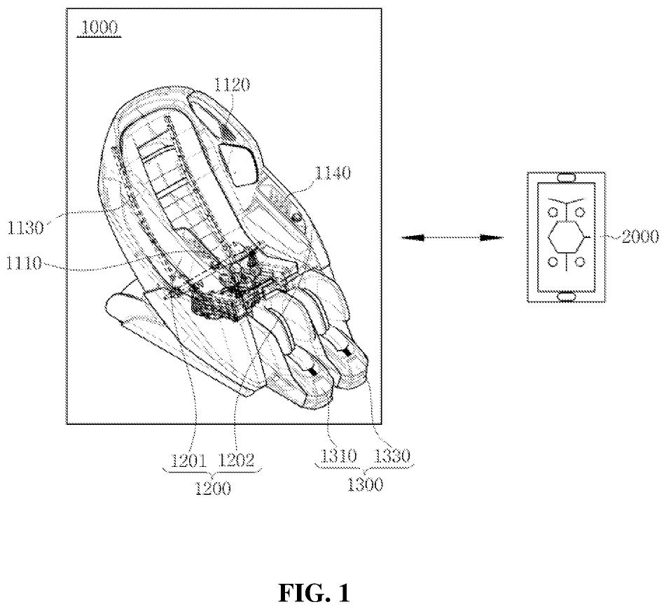

FIG. 1 is a view illustrating a massage device 1000 according to an embodiment of the present invention.

The massage device 1000 according to an embodiment of the present invention has an area for accommodating at least a portion of the body of a user, supports the a body part of the user (for example, the body), and includes a massage unit for massaging a portion of the body of the user.

The massage unit may include at least one of a body massage unit 1100 massaging at least a portion of the body of the user, an arm massage unit 1200 massaging the user's arms, and at least one of leg massage units 1300 massaging the user's legs.

The body massage unit 1100 can massage at least a portion of the body of the user. For example, the body massage unit 1100 can massage at least a portion of at least one of the upper body and the lower body of the user.

Specifically, the body massage unit 1100 may include a massage module 1110 providing a massage function to at least a portion of the body of the user, an audio output module 1120 providing any type of audio output to the user, a main frame 1130 forming the framework of the body massage unit 1100 and supporting the user's body, and a user input unit 1140 receiving any type of input from the user.

The components included in the body massage unit 1100 are just exemplary embodiments, and the body massage unit 1100 may include other various components.

Additionally, the shape and the structure of the massage device 1000 illustrated in FIG. 1 are just examples, and various types of the massage device 1000 can be included within the scope of the present invention without departing from the scope of the present invention defined by the claims of the present invention.

The body massage unit 1100 can form a space of any shape to accommodate the user. The body massage unit 1100 may have a space with the shape corresponding to the shape of the body of the user. For example, as illustrated in FIG. 1, the body massage unit 1100 can be realized as a seat type that can accommodate the user's whole body or a portion of the body and can support at least a portion of the body of the user. For example, the body massage unit 1100 may include a backrest supporting at least a portion of the user's upper body, and a seat supporting at least a portion of the user's lower body.

A portion of the body massage unit 1100 contacting the ground may include any material or component (for example, an anti-slip pad) for increasing frictional force, and may include wheels for enhancing mobility of the massage device 1000.

At least a portion of the body massage unit 1100 can slide. For instance, when the body massage unit 1100 starts a massage (or when the body massage unit 1100 is activated), at least a portion of the body massage unit 1100 can slide forward. Additionally, the body massage unit 1100 can tilt backwards. As a result, the body massage unit 1100 can provide a massage while tilted backwards. For instance, the massage device 1000 may include an actuator that tilts the massage device 1000 or the body massage unit 1100 in the backward direction of the massage device 1000 or the body massage unit 1100. The massage device 1000 can activate the actuator to tilt the body massage unit 1100 or restore the body massage unit 1100 to the original state. In this instance, the actuator can be placed in at least a portion of the massage device (for example, a base frame).

According to an embodiment of the present invention, the massage device 1000 may include at least one air cell (not illustrated). The air cell can be located in at least one area of the body massage unit 1100 (for instance, at least one of an area corresponding to the user's shoulder, an area corresponding to the pelvis, an area corresponding to the waist, out of the entire area of the body massage unit 1100), at least an area of the arm massage unit 1200, and at least an area of the leg massage unit 1300, but is not limited thereto, and may be placed in various parts of the massage device 1000.

The massage device 1000 may include an air supply unit, which can inflate the air cell by supplying air to the air cell. The air supply unit may be located inside the body massage unit 1100 or may be located inside the leg massage unit 1300. Moreover, the air supply unit can be located outside the massage device 1000.

The massage module 1110 may be installed inside the body massage unit 1100 to provide any type of mechanical stimulation to a user accommodated in the body massage unit 1100. As illustrated in FIG. 1, the massage module 1110 can move along the main frame 1130 installed inside the body massage unit 1100. The massage module 1110 can massage at least a portion of the body of the user while moving along the main frame 1130.

The main frame 1130 of the body massage unit 1100 may include a rack gear 1131a, and the massage module 1110 can provide mechanical stimulation to various parts of the body of the user by moving along the rack gear. For example, the massage module 1110 can massage the user's back, shoulders, waist, buttocks, thighs, or at least one of such body parts by tapping or kneading. The massage module 1110 may include at least one massage unit among a ball massage unit and a roller massage unit, but is not limited thereto.

The main frame 1130 can form a frame of the internal configuration of the body massage unit 1100, and may be made of metal or plastic. For example, the main frame 1130 may be made of iron, alloy, steel, etc., but is not limited thereto, and can be made of various hard materials.

The audio output module 1120 may be provided in various locations. For example, the audio output module 1120 may include multiple output units such as a top audio output unit placed on the top of the seat part in contact with the user, a front audio output unit coupled to the front end of the arm massage unit 1200 on both sides of the seat part, and/or a rear audio output unit coupled to the rear end of the arm massage unit 1200, but is not limited thereto. In this case, the audio output module 1120 can provide stereophonic sound such as 5.1 channels, but is not limited thereto.

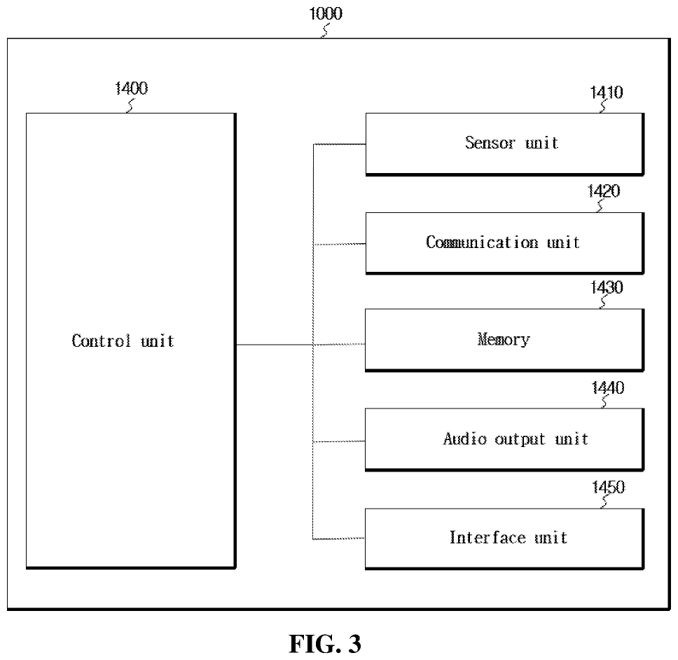

The arm massage unit 1200 may be arranged at least on one side of the body massage unit 1100. For example, the arm massage unit 1200 may include at least one between a first arm massage unit 1210 arranged on one side of the body massage unit 1100 to massage a user's one arm, and a second arm massage unit 1230 arranged on the other side of the body massage unit 1100 to massage the user's other arm. The first arm massage unit 1210 may be arranged on at least one side of the seat part and the backrest part of the body massage unit 1100. The second arm massage unit 1230 may be arranged on the other side of at least one of the seat part and the backrest part of the body massage unit 1100. The first and second arm massage units 1210 and 1230 can operate independently based on the control of a control unit 1400 (refer to FIG. 3) which controls the massage device 1000.

The leg massage unit 1300 may be arranged at the bottom of the body massage unit 1100 and/or at the front bottom of the massage device 1000. The leg massage unit 1300 may include at least one of a first leg massage unit 1310 placed on one side of the leg massage unit 1300 to massage the user's one leg, and a second leg massage unit 1330 placed on the other side of the leg massage unit 1300 to massage the user's other leg.

The leg massage unit 1300 includes a receiving space for accommodating the user's leg, and can provide a leg massage to the user by massaging at least a portion of the user's leg. For example, the leg massage unit 1300 may include a calf massage unit which massages the user's calf and/or a foot massage unit which massages the user's foot.

The leg massage unit 1300 is adjustable in length according to the user's body characteristics. For example, when a user who is tall uses the massage device 1000, it is necessary to extend the length of the leg massage unit 1300 since the user's calves are long. Moreover, when a user who is short uses the massage device 1000, it is necessary to reduce the length of the leg massage unit 1300 since the user's calves are short. Accordingly, the leg massage unit 1300 can provide a leg massage tailored to the user's height. According to an embodiment of the present invention, the user can control the massage device 1000 using a massage device control device 2000. The massage device control device 2000 can be connected to the massage device 1000 through wired communication and/or wireless communication.

The massage device control device 2000 may include at least one user device (personal device), such as a remote controller, a cellular phone, and a PDA (Personal Digital Assistant), but is not limited thereto, and may include various electronic devices that can be connected to the massage device 1000 through wired or wireless communication.

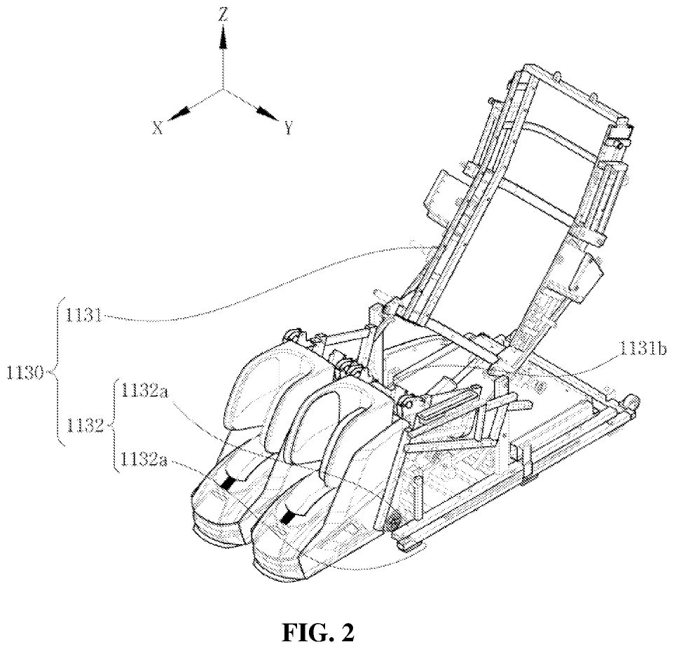

FIG. 2 is a view illustrating a massage device according to an embodiment of the present invention.

According to an embodiment of the present invention, the main frame 1130 may include an upper frame 1131, on which a massage module 1110 is provided, and a base frame 1132 supporting the upper frame 1131.

A rack gear 1131a may be provided on at least a portion of the upper frame 1131. The rack gear 1131a may include a plurality of teeth and a plurality of valleys, as a member for guiding the vertical movement of the massage module 1110.

According to an embodiment of the present invention, the rack gears 1131a may be provided on both sides of the upper frame 1131 to face each other, and the massage module 1110 may move along the rack gears 1131a.

In FIG. 2, the rack gears 1131a are formed in the vertical direction, but are not limited thereto. The rack gears 1131a may include a front-rear direction rack gear and a vertical rack gear. The front-rear direction in the present invention means the direction heading towards the user from the massage module 100 or heading towards the massage module 100 from the user, and may means the X-axis direction based on FIG. 2.

The massage module 1110 may include gears meshing with the rack gears 1131a. More specifically, the massage module 1110 may include gears that respectively mesh with the front-rear direction rack gear and the vertical rack gear. By the rotation of the gear by an actuator equipped on the massage module 1110, the massage module 1110 can move forward, backward, upward, or downward.

As the massage module 1110 moves forward, the intensity of the massage may increase. Additionally, as the massage module 1110 moves backward, the intensity of the massage may decrease.

The rack gear 1131a may be made of metal or plastic materials. For example, the rack gear 1131a may be made of iron, steel, alloy, reinforced plastic, melamine resin, phenolic resin, etc., but is not limited thereto.

The upper frame 1131 may be realized in various shapes. For instance, the upper frame 1131 may be classified into an S-frame, an L-frame, an S&L frame, a double S&L frame according to shapes, but is not limited thereto.

The S-frame refers to a frame where at least a portion of the upper frame 1131 includes a curved shape like “S”. The L-frame means a frame that includes a bent shape like “L” in at least a portion of the upper frame 1131. The S&L frame means a frame including an “S”-shaped curved form and an “L”-shaped bent form. The double S&L frame means a frame including an “L”-shaped bent form and two “S”-shaped curved forms.

The base frame 1132 means a part which supports the upper frame 1131 and contacts the ground or the installation surface of the massage device 1000. The base frame 1132 may include an upper base frame 1132a and a lower base frame 1132b.

The upper base frame 1132a may support the upper frame 1131, and the lower base frame 1132b may come into contact with the ground or the installation surface of the massage device 1000. Additionally, the upper base frame 1132a can be positioned to contact the lower base frame 1132b.

According to an embodiment of the present invention, the upper base frame 1132a can move along the lower base frame 1132b. For instance, the upper base frame 1132a can slide forwards or backwards along the lower base frame 1132b. In this case, the upper frame 1131 is connected to the upper base frame 1132a, can move according to the movement of the upper base frame 1132a.

For example, when the upper base frame 1132a moves forward, the upper frame 1131 can also move forward, and when the upper base frame 1132a moves backward, the upper frame 1131 can also move backward. As a result, the sliding movement of the body massage unit 1100 can be permitted.

To allow the movement of the upper base frame 1132a, a moving wheel may be provided on the underside of the upper base frame 1132a. Additionally, a guide member, which can guide the moving wheel, may be provided on the top of the lower base frame 1132b. The moving wheel provided on the upper base frame 1132a can move along the guide member provided on the lower base frame 1132b, allowing for the forward or backward movement of the upper base frame 1132a.

According to another embodiment of the present invention, the massage device 1000 may not provide a sliding function, and in this case, the base frame 1132 may not be separated into upper and lower frames.

FIG. 3 is a view illustrating a detailed configuration of a massage device according to an embodiment of the present invention.

According to an embodiment of the present invention, the massage device 1000 may include at least one among a control unit 1400, a sensor unit 1410, a communication unit 1420, memory 1430, an audio output unit 1440, and an interface unit 1450. The control unit 1400 may include at least one processor and a memory. The at least one processor can execute instructions stored in memory.

The control unit 1400 can control the massage device 1000. For example, the control unit 1400 can control at least one among the body massage unit 1100, the arm massage unit 1200, the leg massage unit 1300, the sensor unit 1410, the communication unit 1420, the memory 1430, the audio output unit 1440, the interface unit 1450, and the output part. Moreover, the control unit 1400 can control various detailed configurations necessary for the operation of the massage device 1000, which are not described above.

The control unit 1400 may include one processor, or a plurality of processors. When the control unit 1400 includes the plurality of processors, at least some of the plurality of processors can be located at physically distanced locations. In addition, the massage device 1000 is not limited thereto, and can be realized in various ways.

According to an embodiment of the present invention, the control unit 1400 may control the operation of the massage device 1000. For instance, the massage device 1000 may include a plurality of actuators, and the control unit 1400 can control the operation of the massage device 1000 by controlling the operation of the plurality of actuators.

For example, the massage device 1000 may include at least one among a driving unit that moves the armrest frame support, at least one actuator included in the massage module 100, a back angle actuator, a leg angle actuator, a foot massage actuator, a leg length adjustment actuator, and a sliding actuator.

The back angle actuator is an actuator which adjusts the angle of a part of the massage device 1000 contacting with the user's back, and the back angle of the massage device 1000 can be adjusted by the operation of the back angle actuator. The leg angle actuator is an actuator to adjust the angle of the leg massage unit 1300 of the massage device 1000, and the angle between the leg massage unit 1300 and the body massage unit 1100 can be adjusted by the operation of the leg angle actuator. The foot massage actuator represents an actuator that operates the foot massage module included in the leg massage unit 1300. For instance, the control unit 1400 can provide a foot massage to the user using the foot massage actuator. The leg length adjustment actuator represents an actuator that adjusts the length of the leg massage unit 1300. For example, the control unit 1400 can adjust the length of the leg massage unit 1300 to fit the user using the leg length adjustment actuator, and as a result, the user can receive a massage suited to the body shape.

At least one actuator included in the massage module 1110 may be an actuator of various kinds such as a moving actuator, a forward-backward actuator, and a massage actuator.

The moving actuator is an actuator that enables the up and down movement of the massage module 1110, which can move the massage module 1110 in at least one of the upward direction and the downward direction of the massage device 1000 along the main frame 1130. The massage module 1110 can move along the rack gear due to the operation of the moving actuator. The forward-backward actuator can advance (or tilt) the massage module 1110 in at least one of the forward and backward directions. The massage module 1110 can tilt in at least one of the forward and backward directions through the forward-backward actuator. The massage actuator can move the massage module 1110 in various ways to provide various massage actions to the user.

The control unit 1400 can control the operation of the massage device 1000 by controlling the detailed configuration of the massage device 1000.

The control unit 1400 can provide various massage actions by operating at least one actuator included in the massage device 1000. For example, the control unit 1400 can provide a tapping massage, a kneading massage, and so on by operating at least one actuator included in the massage module 1110, but is not limited thereto, and can provide various massage actions.

The memory 1430 may be included in the control unit 1400 or can be located outside the control unit 1400. The memory 1430 can store various pieces of information related to the massage device 1000. For instance, the memory 1430 may include massage control information, user information, and is not limited thereto. User information may contain various kinds of information associated with the user, such as personal authentication information, the user's biometric information (for example, age, height, weight, blood pressure, body composition, pulse, electrocardiogram, etc.) and the like.

The memory 1430 can be realized through a non-volatile storage medium, which can continuously store arbitrary data. For example, the memory 1430 may include storage devices based on a disk, an optical disk, a magneto-optical storage device, a flash memory and/or a battery-backup memory, and is not limited thereto.

The memory 1430 is a first storage device directly accessed by the processor, such as a random access memory (RAM) like a dynamic random access memory (DRAM) and a static random access memory (SRAM), and means a volatile storage device in which stored information is instantly erased when power is turned off, but it is not limited thereto. The memory 1430 can be operated by the control unit 1400.

The massage device 1000 may include a sensor unit 1410. The sensor unit 1410 can acquire various information using at least one sensor. The sensor unit 1410 can be equipped with sensors using measurement means such as pressure, potential, and optics. For example, the sensor unit may include a pressure sensor, an infrared sensor, an LED sensor, a touch sensor, an electrode sensor, an air pressure measurement sensor, but is not limited thereto.

The sensor unit 1410 may include a biometric information acquisition sensor. The biometric information acquisition sensor can acquire at least one of fingerprint information, face information, voice information, iris information, weight information, blood pressure information, heartbeat (or heart rate) information, electrocardiogram information, body composition information, and is not limited thereto, and may include various biometric information. The massage device 1000 can provide a customized massage based on the information acquired through the sensors.

The massage device 1000 can detect a contact area and/or a contact position with the user through the sensors. Moreover, the massage device 1000 can provide a customized massage based on the information acquired through the sensors. The sensor unit 1410 may include a safety sensor module 1500. The safety sensor module 1500 can control the operation of the leg massage unit 1300 or issue a warning to the user when pressed by the user's body or by other objects. A detailed description of the safety sensor module 1500 will be described later.

The communication unit 1420 can receive a signal transmitted from an external device or transmit a signal about the massage device 1000 to the external device.

For example, the control unit 1400 can process the signal received through the communication unit 1420 to acquire a result signal, and can transmit the result signal to the communication unit 1420. The communication unit 1420 can transmit (or output) the result signal to the external device.

The control unit 1400 can acquire information on various components included in the massage device 1000 (for instance, information on the massage module 1110, information on the arm massage unit 1200, etc.), and can transmit the information to the communication unit 1420. The communication unit 1420 can transmit the information regarding the massage device 1000 to the external device.

The communication unit 1420 can communicate with an internal module of the massage device 1000, an external massage device and/or a user terminal via any type of network. The communication unit may include a wired/wireless connection module for network access. For wireless connection technology, for example, there are WLAN (Wireless LAN) (Wi-Fi), Wibro (Wireless broadband), Wimax (World Interoperability for Microwave Access), HSDPA (High-Speed Downlink Packet Access), and the like. For wired connection technology, for instance, there are XDSL (Digital Subscriber Line), FTTH (Fibers to the home), PLC (Power Line Communication), and the like. In addition, the network connection unit may include a short-range communication module, which allows data transmission and reception with any device/terminal located in close range. For short-range communication technology, there are Bluetooth, RFID (Radio Frequency Identification), IrDA (infrared Data Association), UWB (Ultra-Wideband), ZigBee, and the like, and the communication technologies are not limited thereto.

The massage device 1000 may further include an interface unit 1450.

The interface unit 1450 may be arranged on at least a portion of the massage device 1000. For example, the interface unit 1450 may be arranged on the exterior of the arm massage unit 1200.

The interface unit 1450 may include an input unit and/or an output unit. The input unit can receive user input from the user and transmit it to the control unit 1400. The output unit can display information about the massage device 1000. For example, the output unit can display various information such as the processing results of the control unit 1400, operation information of at least one of the body massage unit 1100, the arm massage unit 1200, and the leg massage unit 1300, information on the massage mode being performed.

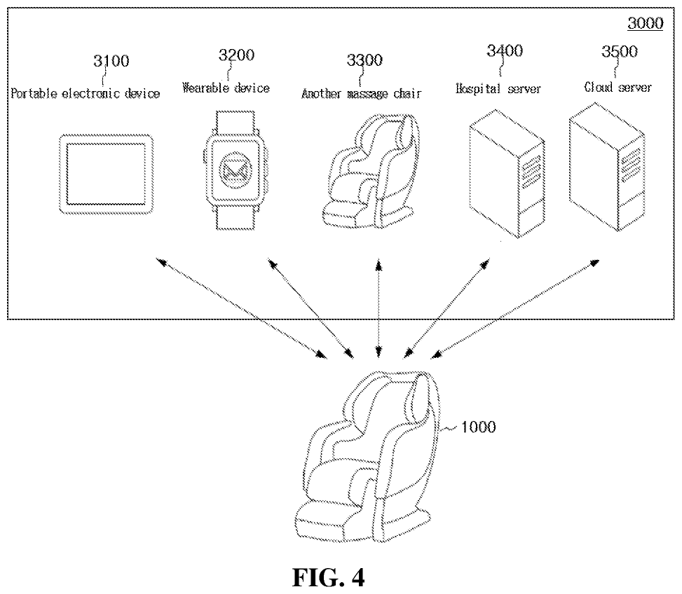

Specifically, the input unit can receive commands related to the operation control of the massage device 1000 from the user, and the input unit may be realized in various forms. For example, the input unit can be equipped in the body massage unit 1100, and can be equipped in the leg massage unit 1300, but is not limited thereto. In addition, the input unit may include a user input unit 1140 of FIG. 1, a massage device control device 2000, or various external devices to be described in FIG. 4.

The massage device 1000 can acquire various commands from the user through the input unit. For example, the massage device 1000 can receive any command for selection of the massage module, selection of massage type, selection of massage intensity, selection of massage time, selection of the massage area, selection related to the position and operation of the body massage unit 1100, on-off selection for the power of the massage device 1000, selection regarding the operation of the heat function, selection related to music playback, and more, but is not limited thereto.

The massage device 1000 can provide an interface for selecting the massage mode through the interface unit 1450. For example, the input unit and/or output unit may include a massage device control device 2000. Medical massages of various modes related to body improvement can be listed through the massage device control device 2000.

The medical massage mode may include at least one among a focus mode, a meditation mode, a recovery mode, a stretching mode, a sleep mode, a vitality mode, a golf mode, a hip up mode, a student mode, a zero gravity mode, and a growth mode.

According to another embodiment of the present invention, the interface unit 1450 may include buttons in the form of a hot key and/or selection buttons to execute direction selection, cancellation, and input, depending on pre-set user settings or its own pre-set functions.

The interface unit 1450 can be realized as a touchscreen, a keypad, a dome switch, a touch pad (pressure/static), a jog wheel, a jog switch, and others, but is not limited thereto. Moreover, the interface unit 1450 can acquire commands through the user's speech based on voice recognition technology.

The output unit may include a display for displaying the operating situation of the massage device 1000 or the current status of the user. In this case, the display may include at least one of a liquid crystal display (LCD), a thin film transistor-liquid crystal display (TFT LCD), an organic light emitting diode (OLED), a flexible display, a 3D display, and the like, but is not limited thereto.

The output unit may include an audio output unit 1440. The audio output unit 1440 of FIG. 3 may include the audio output module 1120 of FIG. 1. For instance, the audio output module 1120 may be arranged at various locations of the massage device 1000. The audio output module 1120 can be placed in the area corresponding to the user's head among the entire areas of the body massage unit 1100 of the massage device 1000 as illustrated in FIG. 1. In this case, the area corresponding to the user's head may be an area corresponding to at least one side of the upper two sides of the entire area of the body massage unit 1100.

The audio output unit 1440 can provide any type of audio output to the user. For example, the audio output unit 1440 can provide brain stimulation to the user by outputting music and/or binaural beats optimized for the massage pattern provided by the massage device 1000. The audio output unit 1440 can output an acoustic signal received through a network (not illustrated) or stored in an internal/external storage medium (not illustrated). For instance, the audio output unit 1440 can output music controlled by the user's terminal through a network connection (e.g., a Bluetooth connection) with the user's terminal. In addition, the audio output unit 1440 can output any type of acoustic signal related to the operation of the massage device 1000.

Those skilled in the art to which the present invention belongs would know well that the present invention can be realized by being combined with other program modules and/or by a combination of hardware and software. For example, the present invention can be realized by a computer-readable medium.

A medium accessible by a computer can be any computer-readable medium, and such a computer-readable medium includes volatile and non-volatile media, transitory and non-transitory media, and removable and non-removable media. As an example, without limitation, a computer-readable medium may include a computer-readable storage medium and a computer-readable transmission medium.

The computer-readable storage medium includes volatile and non-volatile, transitory and non-transitory, removable and non-removable media realized by any method or technology for storing information such as computer-readable instructions, data structures, program modules, or other data. The computer-readable storage medium includes RAMs, ROMs, EEPROMs, flash memories or other memory technology, CD-ROMs, digital video disks (DVD) or other optical disk storage devices, magnetic cassettes, magnetic tape, magnetic disk storage devices or other magnetic storage devices, or any other medium that can be accessed by a computer and used to store desired information, but is not limited thereto.

Hereinafter, referring to the drawings, the massage device 1000 having the rotatable arm massage unit according to an embodiment of the present invention will be described in detail.

Hereinafter, as will be described below, providing a massage to the user's arm should be understood not only as providing a massage (e.g., pressing massage (or acupressure), tapping massage, kneading massage, etc.), but also as including at least one of various actions of the arm massage unit 1200 provided to the user's arm, that is, stretching performed by rotating or expanding the user's arm in a specific direction, and other medical treatments.

Furthermore, the arm massage unit 1200 can also provide a function that minimizes interference between the arm massage unit 1200 and the user's body by rotating at least in one direction when the user sits in the body massage unit 1100 or stands up after using, thereby facilitating the user's seating or standing up from the body massage unit 1100. For instance, just before the user sits in the body massage unit 1100 or just before the user stands up from the body massage unit 1100, a rotation module can rotate both or one side of the arm massage unit 1200 upwards to open at least one side of the body massage unit 1100, making the seating or standing-up motion more convenient. The arm massage unit 1200 can be placed on both sides of the body massage unit 1100. For example, the arm massage units 1200 can be respectively placed in positions (or areas) corresponding to the user's arms over the entire bilateral area of the body massage unit 1100. Each arm massage unit 1200 may have a space to accommodate the user's arm.

The arm massage unit 1200 may include an arm massage unit frame 1210 connected to both sides of the main frame 1130. The arm massage unit frame 1210 can rotate vertically around a rotational shaft 1230 installed on both sides of the main frame 1130. The rotational shaft 1230 can be placed near one end (or the upper end) of the upper frame 1131. In this case, both top ends of the upper frame 1131 correspond to the user's shoulders, and may correspond to the upper rear of the user's shoulders. The rotational shaft 1230 can be directly connected to the upper portion of the upper frame 1131 near the user's bilateral shoulder rear or can be connected to the upper frame via a bracket, or a plate or a frame structure, and can rotate around an axis extending laterally from the top of the upper frame 1131.

An armrest frame support 1212 having a ‘C’-shaped armrest recess 1213 which is opened to the side interior and the rear may be provided on the front side of the arm massage frame 1210. A ‘C’-shaped armrest frame 1214 into which a user's arm is inserted and mounted may be installed inside the armrest recess 1213 of the armrest frame support 1212. The armrest frame 1214 may be formed in a ‘C’ shape corresponding to the armrest recess 1213. Inside the armrest frame 1214, at least one of an air cell, a massage module, and a heating module for massaging the user's arm may be included. The air cell can massage the user's arm area by expanding and contracting through air supply and discharge, the massage module is configured to vibrate the arm area by an actuator, and the heating module is configured to provide a massage effect by applying heat to the arm area.

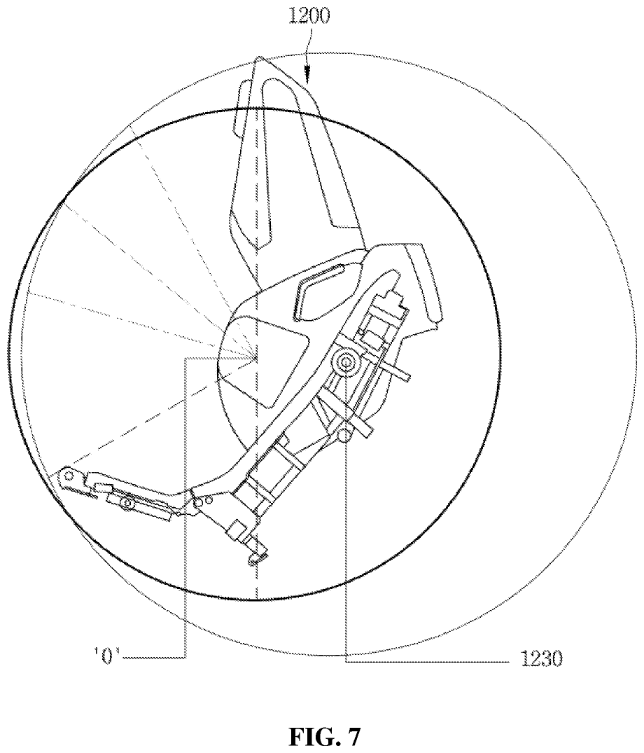

The arm massage frame 1210 can rotate vertically around the rotational shaft 1230 by the rotation module 1270. At this time, as illustrated in FIG. 7, depending on the user's body size, a rotation center (O) of the user's arm may not align with the rotational shaft 1230 of the arm massage frame 1210. In this case, when the arm massage frame 1210 rotates around the rotational shaft 1230, a position difference may occur between the user's arm end and the end of the arm massage frame 1210 depending on an rotational angle.

Such a positional difference, when the arm massage unit 1200 rotates, may cause the user's arm to be excessively pulled, leading to excessive stretching, or exert a force that contracts the user's arm, so may cause discomfort or pain for the user. Therefore, based on the rotational angle of the arm massage unit 1200, the arm massage unit 1200 can naturally linearly move regarding the rotational shaft 1230, and alter the rotation trajectory of the end of the arm massage unit 1200.

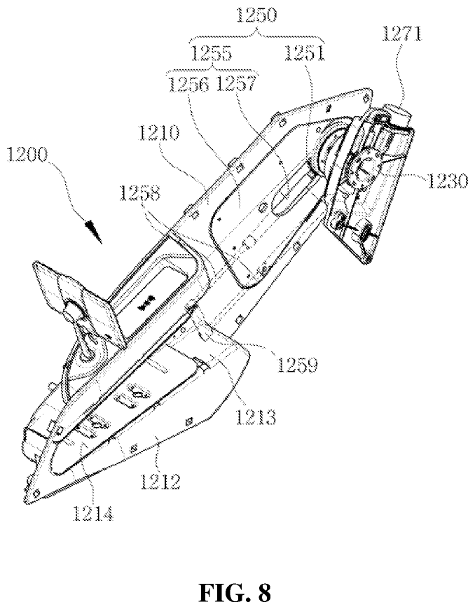

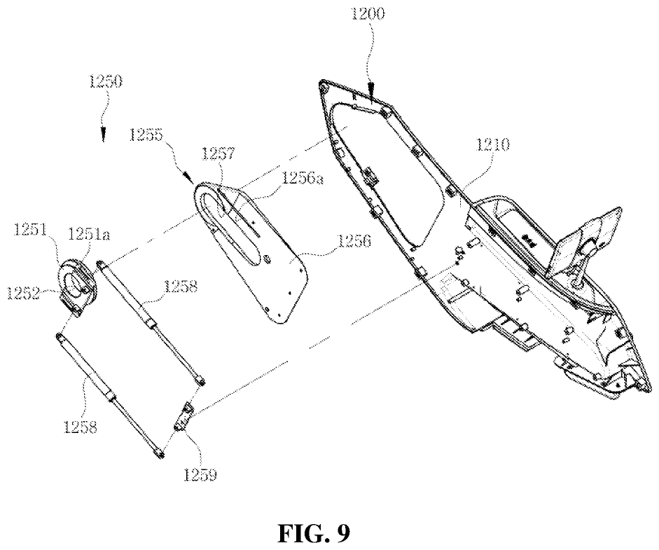

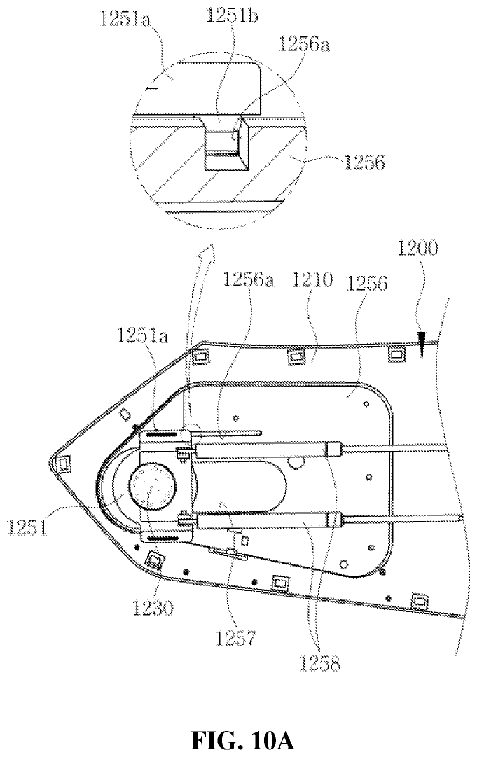

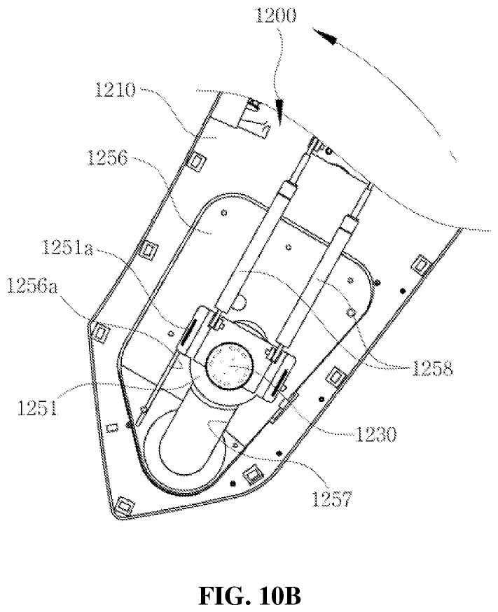

In other words, as illustrated in FIGS. 8 through 11, in conjunction with the rotating action of the arm massage unit 1200 by the rotation module 1270, the arm massage unit 1200 can linearly move in the length direction of the arm massage unit 1200 due to the self-weight, so the position of the end of the arm massage unit 1200 is changed relative to the rotational shaft 1230, and the distance between the end of the arm massage unit 1200 and the body massage unit 1100 can be adjusted. For this purpose, a position adjustment module 1250 is arranged between the arm massage unit 1200 and the rotational shaft 1230.

The position adjustment module 1250 is configured to allow the arm massage unit frame 1210 of the arm massage unit 1200 to linearly move by sliding relative to the rotational shaft 1230 while simultaneously rotating around the rotational shaft 1230. In other words, the position adjustment module 1250 enables the arm massage unit 1200 to linearly move while sliding relative to the rotational shaft 1230 when the arm massage unit 1200 rotates around the rotational shaft 1230 to adjust the distance between the end of the arm massage unit 1200 and the body massage unit 1100.

In one embodiment, the position adjustment module 1250 may include an shaft coupling member 1251 coupled to the rotational shaft 1230, and a guide part 1255 enabling the arm massage unit 1200 to linearly move by sliding relative to the shaft coupling member 1251 but preventing relative rotation.

The guide part 1255 includes a guide hole 1257, which is elongated on the arm massage unit 1200 in one direction so that the shaft coupling member 1251 is connected in such a way as to be slidable but to be prevented in relative rotation. The guide hole 1257 may be formed in a guide plate 1256 which is fixed to the rear side of the arm massage unit frame 1210. While the guide plate 1256 may be fabricated separately from the arm massage unit frame 1210 and subsequently attached to the arm massage unit frame 1210. Alternatively, the guide plate 1256 may be made of materials which are the same as or different from the arm massage unit frame 1210 to be formed integrally with the arm massage unit frame 1210.

The shaft coupling member 1251 may be installed by being slidably inserted into the inside of the guide hole 1257. Around the approximate center of the shaft coupling member 1251, an shaft coupling hole 1252, through which the rotational shaft 1230 passes, is laterally penetrated. Flanges around the shaft coupling hole 1252 and around the rotational shaft 1230 can be joined by fastening means, such as bolts, so that the shaft coupling member 1251 and the rotational shaft 1230 can rotate together. The shaft coupling member 1251 can be coupled to the guide hole 1257 of the guide plate 1256 in a manner that allows sliding in the length direction but prevents relative rotation. Therefore, when the rotational shaft 1230 rotates by the rotation module 1270, the shaft coupling member 1251 coupled to the rotational shaft 1230 also rotates. At this time, the arm massage unit frame 1210 can also rotate with the shaft coupling member 1251. As the arm massage unit frame 1210 rotates with the shaft coupling member 1251, when the arm massage unit 1200 receives a forward or backward force due to the self-weight, the arm massage unit frame 1210 can slide while being guided by the guide hole 1257 and the shaft coupling member 1251 such that the arm massage unit frame 1210 can move naturally linearly in the back-and-forth direction (or in the length direction) relative to the rotational shaft 1230.

In a state in which the user's arm is inserted into the armrest frame 1214 at the front of the arm massage unit frame 1210, when the rotational shaft 1230 rotates upwards by the rotation module 1270 and the arm massage unit frame 1210 also rotates upwards, the arm massage unit 1200 experiences a force to move downwards due to the self-weight, such that the arm massage unit 1200 can move linearly in the backward direction. Specifically, the arm massage unit frame 1210 slides backward while being guided by the guide hole 1257 and the shaft coupling member 1251, thereby enabling the arm massage unit frame 1210 to move linearly backward. Accordingly, the arm massage unit 1200 can be naturally adjusted to a user-preferred position, so that the airbag of the arm massage unit 1200 can be positioned corresponding to the user's arm.

On the contrary, after the arm massage unit 1200 is rotated upward, when being rotated downward to return to its initial state, the arm massage unit 1200 can move linearly in the forward direction. Specifically, the arm massage unit frame 1210 slides forwards while the guide hole 1257 of the arm massage unit frame 1210 is guided by the shaft coupling member 1251, so that the arm massage unit frame 1210 moves linearly forward.

To prevent shaking while the arm massage unit frame 1210 is guided by the shaft coupling member 1251 and slides in the back-and-forth direction and as soon as rotating vertically by the shaft coupling member 1251, and to allow the arm massage unit frame 1210 to slide smoothly relative to the shaft coupling member 1251, the guide part 1255 may further include a rail groove 1256a formed on the arm massage unit 1200 to be parallel to the length direction of the guide hole 1257, and a rail protrusion 1251b formed on the shaft coupling member 1251 formed to slide along the rail groove 1256a. For example, the guide plate 1256 may have a rail groove 1256a formed parallel to the guide hole 1257, and at least one rail protrusions 1251b protruding from at least one of both wing portions 1251a of the shaft coupling member 1251 to slide along the inner face of the rail groove 1256a. Conversely, the rail groove may be formed on the shaft coupling member 1251, and the rail protrusion may be formed on the guide plate 1256 of the arm massage unit frame 1210.

As described above, in order to reduce the load applied to the arm massage unit frame 1210 when the arm massage unit frame 1210 slides and moves linearly with respect to the shaft coupling member 1251 in conjunction with the rotational action of the arm massage unit frame 1210, the position adjusting module 1250 may further include a cushioning member 1258 which provides elasticity to the arm massage unit frame 1210 with respect to the shaft coupling member 1251.

The cushioning member 1258 has one end connected to the shaft coupling member 1251 and the other end connected to the arm massage unit frame 1210, thereby providing an elastic force to the arm massage unit frame 1210 relative to the shaft coupling member 1251 to provide a cushioning action when the arm massage unit frame 1210 slides with guidance from the guide hole 1257 and the shaft coupling member 1251. In one embodiment, the cushioning member 1258 may be one or more gas cylinders filled with gas or having a built-in spring. In another embodiment, the cushioning member 1258 may be composed using a spring. In a case that multiple gas cylinders are applied as the cushioning member 1258, one end of the gas cylinder may be connected to the arm massage unit frame 1210 by the cylinder bracket 1259.

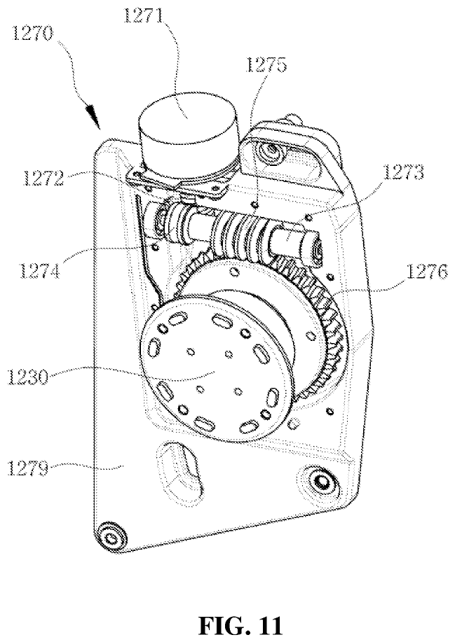

The rotation module 1270, which rotates the arm massage unit 1200 vertically relative to the main frame 1130, can be configured to rotate the shaft coupling member 1251 by transmitting rotational force to the rotational shaft 1230 and to rotate the arm massage unit frame 1210 by the rotation of the shaft coupling member 1251. Referring to FIG. 11, the rotation module 1270 may include a module frame 1279 fixed to one side of the main frame 1130, a rotational shaft 1230 rotatably coupled to the module frame 1279, a motor 1271 transmitting rotational force to the rotational shaft 1230, a first worm gear 1272 receiving the rotational force from the motor 1271, a rotational force transmission shaft 1273 of which ends are freely rotatably connected to the module frame 1279, first worm wheels 1274 and second worm gears 1275 located on both sides of the rotational force transmission shaft 1273, and a second worm wheel 1276 receiving rotational force from the second worm gear 1275.

The motor 1271 is installed on one side (in this embodiment, the upper end) of the module frame 1279, and can operate by receiving power from the control unit 1400 of the massage device (see FIG. 3).

The first worm gear 1272 is axially coupled to the motor 1271 and can rotate by receiving rotational force from the motor 1271.

The first worm wheel 1274 and the second worm gear 1275 are provided on both ends of the rotational force transmission shaft 1273, and can rotate together with the rotational force transmission shaft 1273. The rotational force transmission shaft 1273 can be freely rotatably installed on the module frame 1279 through bearings 1278.

The first worm wheel 1274 is provided at one end of the rotational force transmission shaft 1273, and meshed with the first worm gear 1272 to receive the rotational force from the first worm gear 1272. The second worm gear 1275 is provided at the other end of the rotational force transmission shaft 1273, and meshed with the second worm wheel 1276 coupled to the rotational shaft 1230 to transmit the received rotational force to the second worm wheel 1276.

The second worm wheel 1276 is positioned on the external circumferential part of the rotational shaft 1230, and rotates upon receiving rotational force from the second worm gear 1275. At this time, the second worm wheel 1276 can be coupled to the external circumferential part of the rotational shaft 1230 by a coupling member (for example, an adhesive, screws, and the like).

Therefore, when the motor 1271 receives power from the control unit 1400 (see FIG. 3) and rotates in any one direction, the first worm gear 1272 can receive the rotational force from the motor 1271 and transmit the rotational force to the rotational force transmission shaft 1273 to rotate the rotational force transmission shaft 1273. The rotational force of the rotational force transmission shaft 1273 is transmitted to the second worm wheel 1276 through the second worm gear 1275, thereby enabling the second worm wheel 1276 and the rotational shaft 1230 to rotate.

The rotation module 1270, which includes the first worm gear 1272, the first worm wheel 1274, the second worm gear 1275, and the second worm wheel 1276, can prevent the arm massage unit 1200 from falling and causing an accident in the event of an emergency where the power supply to the motor 1271 is cut off during the rotational operation of the arm massage unit 1200.

In other words, since the worm gears and the worm wheels forms a power transmission mechanism that cannot transmit power through reverse rotation, if the power supplied to the motor 1271 is cut off and the motor 1271 stops operation, even if the arm massage unit 1200 is subjected to a downward load due to its self-weight, the first worm gear 1272, the first worm wheel 1274, the second worm gear 1275, and the second worm wheel 1276 will not transmit rotational force. As a result, the arm massage unit 1200 can maintain its stationary state without rotation and falling.

Furthermore, even if an unintended external force is applied to the arm massage unit 1200 in a direction opposite to the rotational direction, the first worm gear 1272, the first worm wheel 1274, the second worm gear 1275, and the second worm wheel 1276 can prevent the arm massage unit 1200 from rotating in the opposite direction.

In the massage device according to the described embodiment, as the rotational shaft 1230 is rotated by the rotation module 1270, the arm massage unit 1200 rotates around rotational shaft 1230. Depending on the rotation angle of the arm massage unit 1200, due to the self-weight, the arm massage unit 1200 can slide along the shaft coupling member 1251 coupled to the rotational shaft 1230, so that the arm massage unit 1200 can move naturally in the forward and backward direction (or lengthwise) and the position of one end of the arm massage unit 1200 can be adjusted.

Therefore, when performing stretching or massage motions by rotating the arm massage unit 1200, the position of one end of the arm massage unit 1200 relative to the body massage unit 1100 can be naturally adjusted without using any actuator or driving device for moving the arm massage unit 1200, thereby allowing the airbag provided in the arm massage unit 1200 to be adjusted to the user's preferred position.

When the position of one end of the arm massage unit 1200 relative to the body massage unit 1100 is adjusted, the user's arm can be rotated without excessive stretching or strain. Therefore, the present invention can prevent arm injuries, overcome the issue of the arm detaching from the arm massage unit 1200, and safely perform arm stretching actions.

Additionally, through the cushioning member 1258, the arm massage unit 1200 is prevented from sliding excessively, thereby improving durability, reducing noise, and enhancing accuracy and stability in movement of the arm massage unit 1200. Accordingly, consumers' satisfaction with the massage device can be improved.

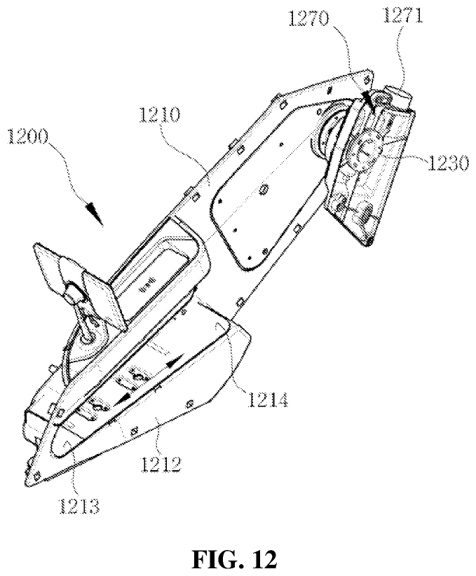

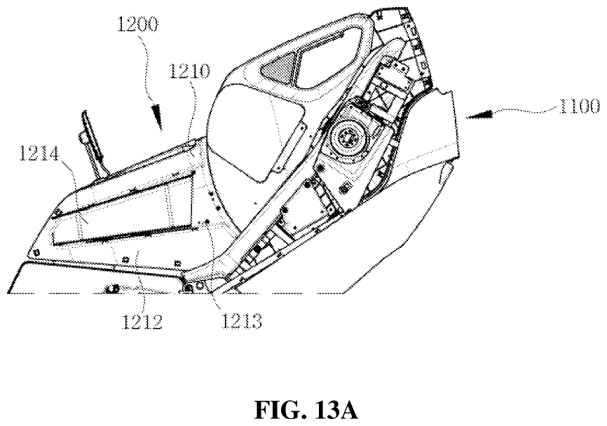

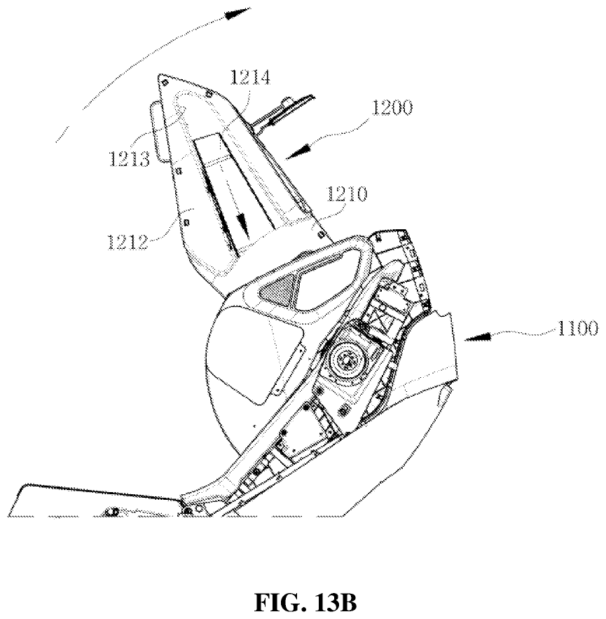

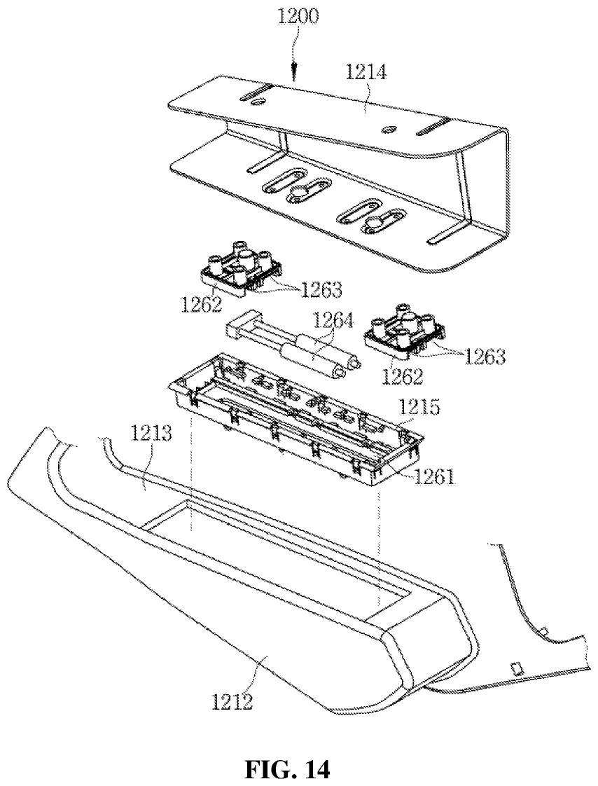

FIGS. 12 through 15 illustrate a massage device according to another embodiment of the present invention.

In the massage device 1000 of this embodiment, the arm massage unit frame 1210 constituting the arm massage unit 1200 does not move forward and backward relative to the rotational shaft 1230. When the arm massage unit frame 1210 rotates around the rotational shaft 1230, the armrest frame 1214 installed on the front side of the arm massage unit frame 1210 can slide in the back-and-forth direction to be automatically adjusted in position.

For example, the massage device 1000 of this embodiment may include a position adjustment module 1260 which adjusts the position of the armrest frame 1214 by synchronizing with the rotational action of the arm massage unit 1200 so that linear movement of the arm massage unit 1200 in the back-and-forth direction by self-weight occurs.

The position adjustment module 1260 may include a position adjustment rail 1261 installed to extend in the back-and-forth direction on the inner side of the armrest groove 1213 of the armrest frame support 1212, an armrest frame 1214 which moves along the position adjustment rail 1261 when the arm massage frame 1210 rotates around the rotational shaft 1230, and a frame cushioning member 1264 which provides an elastic force to the armrest frame 1214 in the back-and-forth direction relative to the armrest frame support 1212 when the armrest frame 1214 moves along the position adjustment rail 1261.

The arm massage unit 1200 may include an arm massage frame 1210 connected to both sides of the main frame 1130. The arm massage frame 1210 can rotate vertically around the rotational shaft 1230 installed on both sides of the main frame 1130. As in the described embodiment, the rotational shaft 1230 can be positioned near one end (or upper end) of the upper frame 1131. At this time, both upper ends of the upper frame 1131 can correspond to the user's shoulders, such as the top rear of both shoulders of the user. The rotational shaft 1230 can be directly connected to the upper portion of the upper frame 1131 near the user's bilateral shoulder rear or can be connected to the upper frame via a bracket, or a plate or a frame structure, and can rotate around an axis extending laterally from the top of the upper frame 1131.

The arm massage frame 1210 can rotate vertically around the rotational shaft 1230 by the rotation module 1270. The rotation module 1270 has the structure and operation which are identical or similar to those of the rotation module 1270 described with reference to FIGS. 8 through 11, so a detailed description thereof will be omitted.

A ‘C’-shaped armrest frame 1214 into which a user's arm is inserted and mounted may be installed inside the armrest recess 1213 of the armrest frame support 1212 to move in the back-and-forth direction or in the length direction by being guided by a position adjustment rail 1261. The armrest frame 1214 may be formed in a ‘C’ shape corresponding to the armrest recess 1213. Inside the armrest frame 1214, at least one of an air cell, a massage module, and a heating module for massaging the user's arm may be included. The air cell can massage the user's arm area by expanding and contracting through air supply and discharge, the massage module is configured to vibrate the arm area by an actuator, and the heating module is configured to provide a massage effect by applying heat to the arm area.

On the lower surface of the armrest frame support 1212, an armrest lower frame 1215 having the position adjustment rail 1261 may be installed. The armrest lower frame 1215 can have a rectangular shape with an open top surface. Within the internal space of the armrest lower frame 1215, one or more position adjustment rails 1261 may be installed to extend in the back-and-forth direction or in the length direction. The position adjustment rail 1261 may have a polygonal bar shape like a rectangle or a circular bar. Additionally, the position adjustment rail 1261 may also be constructed using a linear guide rail (LM guide rail), slide rail, etc.

The armrest frame 1214 can be connected to the position adjustment rail 1261 through a rail connection member 1262 to slide along the position adjustment rail 1261. The rail connection member 1262 can be coupled to the lower surface of the armrest frame 1214 and accommodated within an inner space of the armrest lower frame 1215 to move in the length direction by being guided by the position adjustment rail 1261. Furthermore, the rail connection member 1262 may have an approximate cuboid shape having a guide groove 1263 formed to correspond to the position adjustment rail 1261. For instance, the rail connection member 1262 can move stably by being guided by the position adjustment rail 1261 inserted into the guide groove 1263.

The armrest frame 1214 or the rail connection member 1262 can be connected to the frame cushioning member 1264. The frame cushioning member 1264 operates in conjunction with the rotating movement of the arm massage unit frame 1210 to elasticity to the armrest frame 1214 against the armrest frame support 1212 when the armrest frame 1214 slides and linearly moves relative to the position adjustment rail 1261, thereby reducing the load applied to the armrest frame 1214.

The frame cushioning member 1264 can be accommodated within the internal space of the armrest lower frame 1215. At this time, the frame cushioning member 1264 may be a gas cylinder or a spring of which one end is connected to the armrest lower frame 1215, and the other end is connected to the armrest frame 1214 or the rail connection member 1262.

According to this embodiment, as the rotational shaft 1230 rotates by the rotation module 1270, the arm massage unit frame 1210 rotates around the rotational shaft 1230. Depending on the rotation angle of the arm massage unit frame 1210, the armrest frame 1214 slides while being guided by the position adjustment rail 1261 due to the self-weight of the armrest frame 1214, so that the arm massage unit 1200 naturally moves in the back-and-forth direction relative to the rotational shaft 1230, thereby automatically adjusting the position of the armrest frame 1214.

In this instance, the frame cushioning member 1264 provides elasticity in the opposite direction to the movement direction of the armrest frame 1214 to reduce the movement speed of the armrest frame 1214, so that the armrest frame 1214 can move smoothly within the armrest groove 1213.

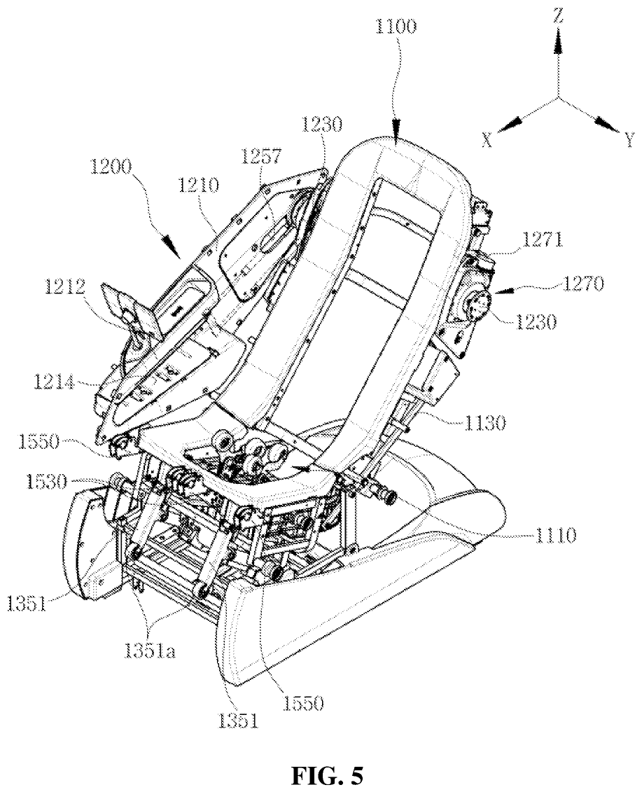

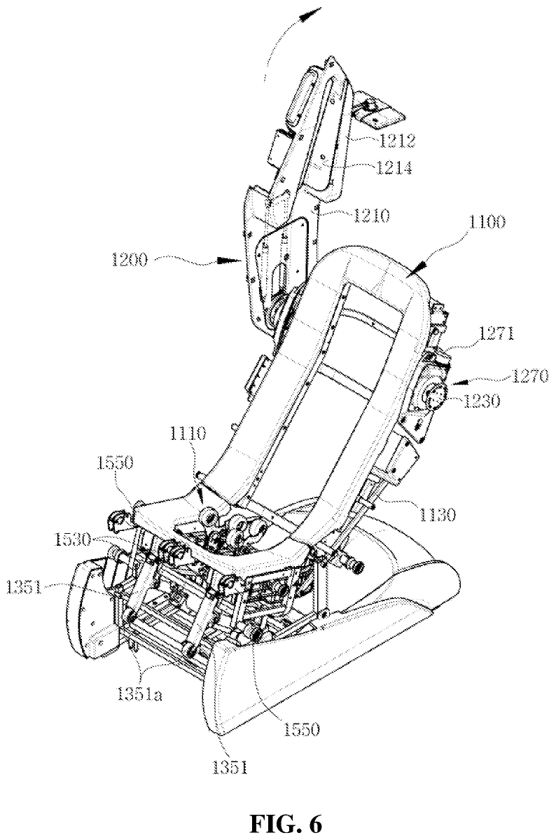

Referring to FIGS. 12 to 15, when the arm massage unit 1200 rotates around the rotational shaft 1230, the armrest frame 1214 can slide automatically in the back-and-forth direction or in the length direction due the self-weight. However, similar to the embodiment of the massage device described with reference to FIGS. 5 through 11, when the position of the arm massage unit 1200 is adjusted while the arm massage unit 1200 rotates around the rotational shaft 1230 and linearly moves in the back-and-forth direction relative to the rotational shaft 1230, a user can manually slide the armrest frame 1214 in the back-and-forth direction or in the length direction to adjust the position of the arm massage unit 1200, so that the user can adjust the position to a desired position.

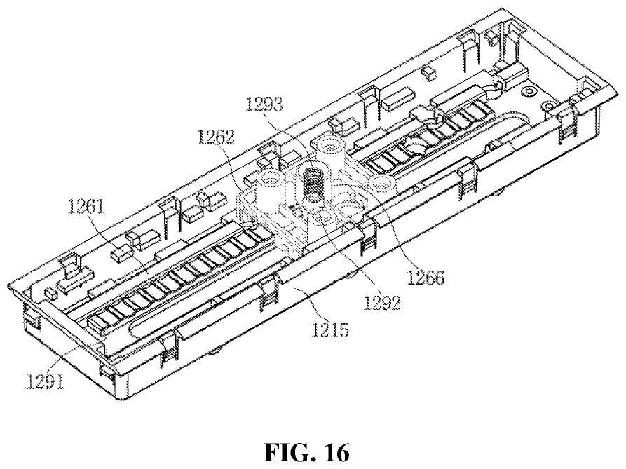

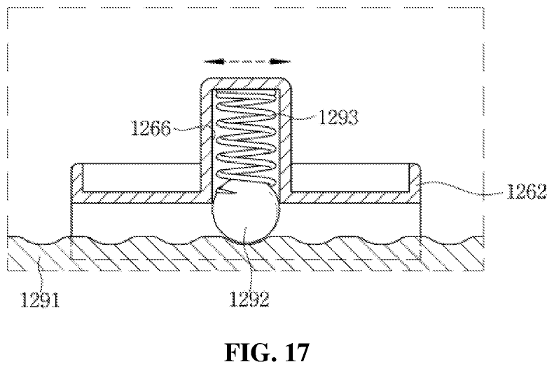

For instance, as illustrated in FIGS. 16 and 17, a support sub-frame 1215 on which the position adjustment rail 1261 is installed to extend in the back-and-forth direction is installed on the bottom surface of an armrest frame support 1212 (see FIG. 12) of the arm massage unit frame 1210 (see FIG. 12), and a concavo-convex portion 1291 is installed parallel with the position adjustment rail 1261 inside the support sub-frame 1215. The concavo-convex portion 1291 may have a bar shape formed with alternating protrusions and indentations on the upper surface.

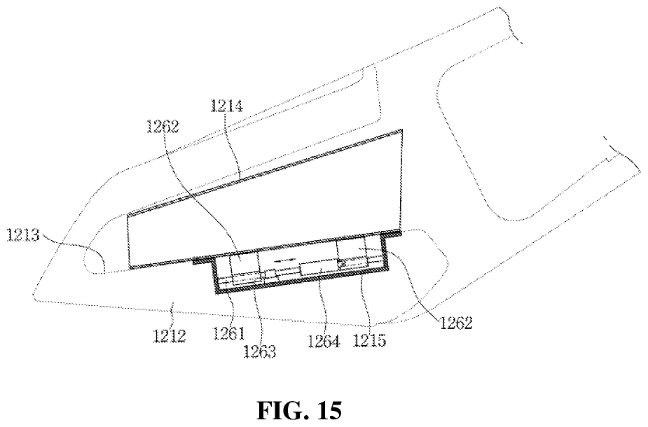

In addition, a guide groove 1263, into which the position adjustment rail 1261 is inserted and guided may be formed on a rail connection member 1262 coupled to the bottom surface of the armrest frame 1214 (see FIG. 15). Moreover, the rail connection member 1262 may include a fixation protrusion 1292 elastically inserted into the indentation of the concavo-convex portion 1291, and an elastic body 1293 providing elasticity to the fixation protrusion 1292 downwards. The fixation protrusion 1292 and the elastic body 1293 may be installed inside an accommodation recess 1266 formed in the rail connection member 1262. The fixation protrusion 1292 may have a ball shape, and the elastic body 1293 may include a spring, rubber, or sponge.

The fixation protrusion 1292, due to the elasticity of the elastic body 1293, may be caught to the concavo-convex portion 1291 by receiving elasticity from the rail connection member 1262 towards the support sub-frame 1215. The user can position the armrest frame 1214 at a comfortable position due to the concavo-convex portion 1291 and the fixation protrusion 1292 provided on the rail connection member 1262. That is, the user makes the fixation protrusion 1292 caught to another groove included in the concavo-convex portion 1291 by applying force in the back-and-forth direction or in the length direction, thereby easily adjusting the position of the armrest frame 1214 to a desired position.

Therefore, when the arm massage unit 1200 rotates around the rotational shaft 1230 and the entire arm massage unit frame 1210 linearly moves relative to the rotational shaft 1230 adjusting the position of the arm massage unit frame 1210, when the user pushes the armrest frame 1214 forward or pulls the armrest frame 1214 backward, the fixation protrusion 1292 can move over the protrusions and indentations of the concavo-convex portion 1291 and the armrest frame 1214 is fixed at the desired position, so that the position can be adjusted.

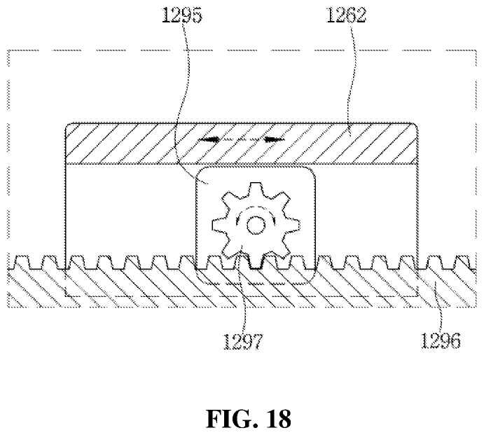

Alternatively, as illustrated in FIG. 18, the position of the armrest frame 1214 (see FIG. 15) can be adjusted to a desired position while being moved in the back-and-forth direction or in the length direction from the arm massage unit 1200 by a driving unit using a motor.

For example, a position adjustment rail 1261 which guides the rail connection member 1262 in the back-and-forth direction and a rack gear 1296 may be installed to extend in the back-and-forth direction within the support sub-frame 1215 installed on the bottom surface of the armrest frame support 1212 (see FIG. 15). Additionally, a position adjustment motor 1295 which operates upon receiving a control signal from the control unit 1400 (see FIG. 3), and a pinion gear 1297 which rotates by the position adjustment motor 1295 may be installed on the rail connection member 1262. The pinion gear 1297 meshes with the rack gear 1296, and changes the back-and-forth position while rolling along the rack gear 1296 as the pinion gear 1297 rotates by the position adjustment motor 1295.

In a case in which the back-and-forth position of the armrest frame 1214 is adjusted by using the position adjustment motor 1295, the pinion gear 1297, and the rack gear 1296, the position adjustment rail 1261 may be omitted.

Meanwhile, when the arm massage unit 1200 of the massage device rotates upwards around the rotational shaft 1230, a space is formed between the lower portion of the arm massage unit 1200 and the side of the body massage unit 1100. Through the space, a pet or a child may enter, and, in this instance, when the arm massage unit 1200 rotates downwards, an accident (for example, jam in the arm massage unit) may occur.

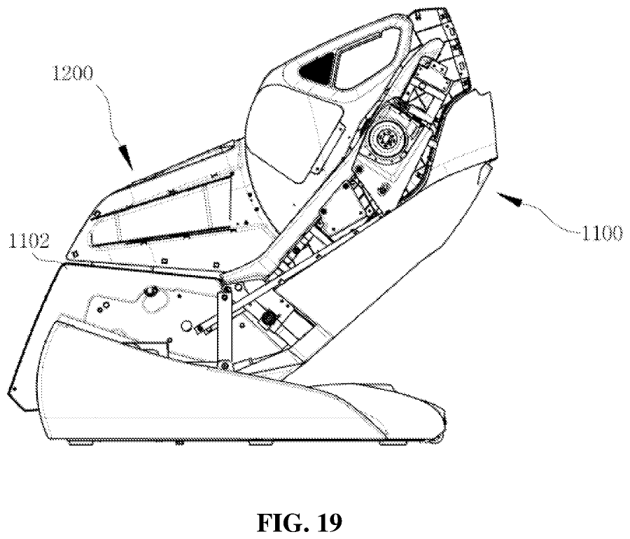

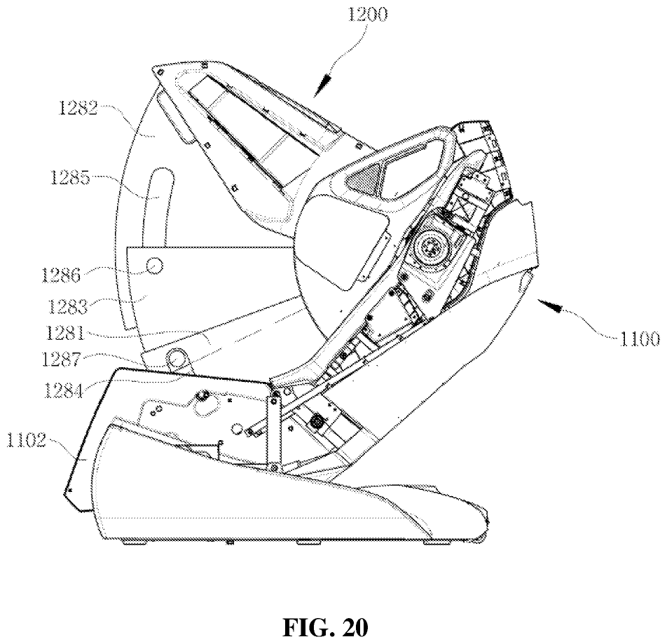

To prevent such an accident, as illustrated in FIGS. 19 and 20, when the arm massage unit 1200 rotates upwards around the rotational shaft 1230, side shields 1281, 1282, and 1283 may be installed to block the space formed between the lower portion of the arm massage unit 1200 and the side of the body massage unit 1100. The side shields 1281, 1282, and 1283 may either be installed as a single unit or multiple units connected in stages to be unfold or fold according to the rotation of the arm massage unit 1200.

For instance, the side shields 1281, 1282, and 1283 may include a lower side shield 1281 coupled to one side of the body massage unit 1100, an upper side shield 1282 coupled to the arm massage unit 1200 and moving with the arm massage unit 1200, and a middle side shield 1283 connected between the lower side shield 1281 and the upper side shield 1282 to move vertically.

The lower side shield 1281 can be fixed to a side plate 1102 installed on the side of the body massage unit 1100. The lower side shield 1281 can be coupled to the side plate 1102 to prevent the side plate 1102 from being separated to the outside.

The top of the upper side shield 1282 can be fixed to at least one of the bottom or the side of the frame 1210 of the arm massage unit 1200.

The middle side shield 1283 can be slidably installed between one side (for example, the outer side) of the lower side shield 1281 and one side (for example, the inner side) of the upper side shield 1282.

The lower side shield 1281 and the upper side shield 1282 respectively have a lower guide hole 1284 and an upper guide hole 1285 which are formed in an arc shape to extend vertically, and a lower towing pin 1287 and an upper towing pin 1286 which are respectively inserted and guided into the lower guide hole 1284 and the upper guide hole 1285 are respectively provided on the upper portion and the lower portion of the middle side shield 1283.

When the arm massage unit 1200 rotates upward, the upper side shield 1282 may rotate upward together with the arm massage unit 1200. At this time, if the bottom of the upper guide hole 1285 is caught to the upper towing pin 1286 of the middle side shield 1283, the middle side shield 1283 is towed and moved upward, and spread out. In this instance, the lower towing pin 1287 of the middle side shield 1283 may be guided while moving along the lower guide hole 1284.

In this manner, the lower side shield 1281, the middle side shield 1283, and the upper side shield 1282 can spread out while sliding in relation to each other, so as to shield the space between the bottom of the arm massage unit 1200 and the side of the body massage unit 1100, thereby preventing an accident, such as a pet or a child getting caught.

As the arm massage unit 1200 rotates downward, the folding process of the lower side shield 1281, the middle side shield 1283, and the upper side shield 1282 can be performed in reverse of the aforementioned procedure.

In this embodiment, one middle side shield 1283 is placed between the lower side shield 1281 and the upper side shield 1282. However, according to circumstances, the middle side shield 1283 may not be provided, or two middle side shields 1283 may be provided.

Furthermore, one or more side shields in a corrugated shape or a bellows shape may be configured to fold or unfold according to the rotation of the arm massage unit 1200, thereby easily shielding the space between the bottom of the arm massage unit 1200 and the side of the body massage unit 1100. In addition, various foldable shield structures may be applied to the side shields. Meanwhile, as illustrated in FIGS. 5 and 21 through 22, the massage device 1000 according to an embodiment of the present invention may further include leg massage units 1300, which are independently rotatable.

The leg massage units 1300 can be provided to correspond to both legs of the user. For instance, the leg massage units 1300 may include a first leg massage unit 1310, which corresponds to one leg of the user, and a second leg massage unit 1330, which corresponds to the other leg of the user.

The first leg massage unit 1310 and the second leg massage unit 1330 can be controlled independently. For example, the first leg massage unit 1310 and the second leg massage unit 1330 can individually provide a massage function to the user. Additionally, the first leg massage unit 1310 and the second leg massage unit 1330 can rotate independently. As occasion demands, the user may receive different massages on each leg or receive a massage on both legs alternatingly. Additionally, the user may receive stretching or massages on both legs due to rotation. In this case, the first leg massage unit 1310 and the second leg massage unit 1330 may rotate both legs of the user simultaneously or individually.

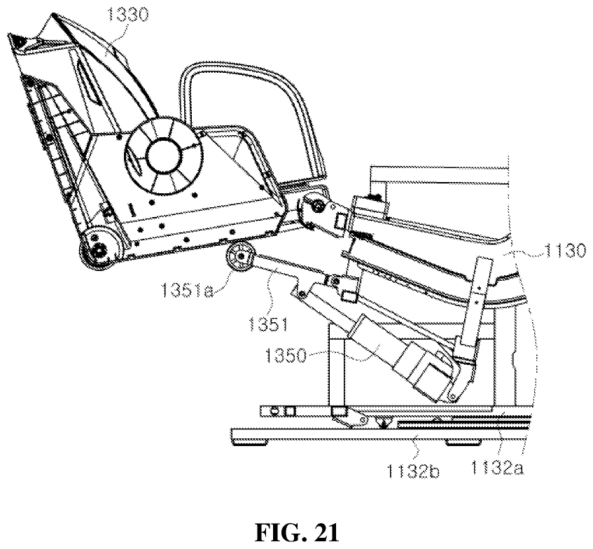

Referring to FIG. 21, the massage device 1000 may include a leg angle actuator 1350 for rotating the leg massage unit 1300. The leg angle actuator 1350 may be arranged inside the body massage unit 1100. For example, the leg angle actuator can be connected to the main frame 1130.

The leg angle actuator 1350 can be driven to extend in one direction. As the leg angle actuator 1350 extends, the leg massage unit 1300 can rotate. The leg angle actuator 1350 can be provided to correspond individually to the first leg massage unit 1310 and the second leg massage unit 1330. Two leg angle actuators 1350 can be connected to the first leg massage unit 1310 and the second leg massage unit 1330, respectively, to rotate the first leg massage unit 1310 and the second leg massage unit 1330 independently.

The leg angle actuator 1350 may include a link member 1351 at an end. The link member 1351 gets in contact with the leg massage unit 1300 to provide rotational force to the leg massage unit 1300. The link member 1351 may have a wheel 1351a provided at an end portion facing the leg massage unit 1300.

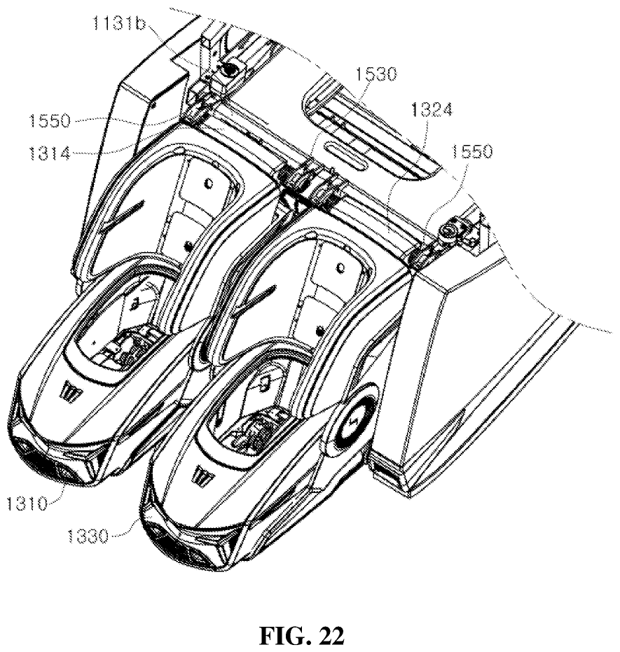

Referring to FIGS. 2 and 22, the leg massage unit 1300 can be rotatably connected to the leg connection frame 1131b arranged on the main frame 1130. The upper frame 1131 may include the leg connection frame 1131b. The leg connection frame 1131b can be provided at the front end of the upper frame 1131. The leg connection frame 1131b can be manufactured as a separate component and coupled to the upper frame 1131 or can be manufactured integrally with the upper frame 1131. In the case in which the leg connection frame 1131b is manufactured integrally with the upper frame 1131, it means that the leg connection frame 1131b is a component of the upper frame 1131.

A center support bracket 1530 and a side support bracket 1550 may be connected to the central portion and both end portions of the leg connection frame 1131b. For instance, the center support bracket 1530 and the side support brackets 1550 may be welded to the leg connection frame 1131b or may be coupled by fastening members such as bolts or rivets. However, the method of coupling the center support bracket 1530 and the side support brackets 1550 to the leg connection frame 1131b may be replaced with various methods commonly used in the technical field to which the present invention belongs.

The center support bracket 1530 and the side support brackets 1550 can fix the leg massage unit 1300 to be rotatable.

The first leg massage unit 1310 and the second leg massage unit 1330 may be located at the front of the leg connection frame 1131b. For example, the first leg massage unit 1310 may be arranged on the right side at the front of the leg connection frame 1131b, and the second leg massage unit 1330 may be arranged on the left side at the front of the leg connection frame 1131b.

Although the present invention has been described with reference to exemplary embodiments along with the accompanying drawings, it should be understood that this is merely exemplary and not intended to limit the present invention. Furthermore, it is evident to those skilled in the art that various modifications and variations can be made within the scope of the technical concept of the present invention without departing from the scope thereof.

Additionally, the configuration and functions of the massage device in this specification can be expanded and applied to various (wearable) healthcare devices capable of providing healthcare functions (e.g., massage functions, biometric signal measurement functions, etc.). Therefore, the term ‘massage device’ in this specification can be replaced with ‘(wearable) healthcare device’ as well.

What is claimed is:

1. A massage device comprising:
a body massage unit including a main frame forming the skeleton of the massage device, and massaging a user's body;
arm massage units respectively arranged on both sides of the body massage unit, accommodating both arms of the user, and configured on the body massage unit to rotate around a rotational shaft;
a rotation module for rotating the arm massage units in at least one direction; and
a position adjustment module operating in conjunction with the rotation action of the arm massage units by the rotation module to allow linear movement of the arm massage units due to the self-weight of the arm massage units.

2. The massage device according to claim 1, wherein the position adjustment module allows the arm massage units to linearly move while sliding relative to the rotational shaft when the arm massage unit rotates around the rotational shaft.

3. The massage device according to claim 2, wherein the position adjustment module comprises:
a shaft coupling member combined with the rotational axis; and
a guide part which connects the arm massage units in a way to allow linear movement but prevent relative rotation with respect to the shaft coupling member.

4. The massage device according to claim 3, wherein the guide part includes a guide hole which is elongated on the arm massage unit in one direction so that the shaft coupling member is connected in such a way as to be slidable but to be prevented in relative rotation.

5. The massage device according to claim 4, wherein the guide part further includes a rail groove formed on the arm massage unit to be parallel to the length direction of the guide hole, and a rail protrusion formed on the shaft coupling member formed to slide along the rail groove.

6. The massage device according to claim 3, wherein the position adjustment module further comprises a cushioning member of which one end is connected to the shaft coupling member and the other end is connected to the arm massage unit to provide elasticity to the arm massage unit relative to the shaft coupling member when the arm massage unit slides relative to the shaft coupling member by being guided by the guide part.

7. The massage device according to claim 1, wherein the arm massage unit comprises an arm massage frame installed to vertically rotate around a rotational shaft installed on the main frame, and an armrest frame support having an armrest groove formed on the front side of the arm massage unit frame, and
wherein the position adjustment module includes: a position adjustment rail installed on the inner side of the armrest groove of the armrest frame support in the back-and-forth direction; an armrest frame which moves along the position adjustment rail when the arm massage frame rotates around the rotational shaft, and into which the user's arm is inserted and placed; and a frame cushioning member which provides an elastic force to the armrest frame in the back-and-forth direction relative to the armrest frame support when the armrest frame moves along the position adjustment rail.

8. The massage device according to claim 1, wherein the arm massage unit includes: an arm massage unit frame installed to rotate vertically around the rotational shaft mounted on the main frame; an armrest frame support having an armrest groove formed on the front side of the arm massage frame; and an armrest frame rotatably positioned inside the armrest groove to be movable in the back-and-forth direction on the inner face of the armrest groove and into which the user's arm is inserted and placed,
wherein a concavo-convex portion which has protrusions and grooves alternatingly formed on the inner face of the armrest groove of the armrest frame support is installed in the back-and-forth direction, and a fixation protrusion elastically inserted into the groove of the concavo-convex portion and an elastic body providing elastic force to the fixation protrusion downwards are installed below the armrest frame.

9. The massage device according to claim 1, wherein the arm massage unit comprises:
an arm massage frame installed to rotate vertically around the rotational shaft mounted on the main frame; an armrest frame support having an armrest groove formed on the front side of the arm massage frame; and an armrest frame installed inside the armrest groove to move in a front-back direction where the user's arm is inserted and held, and
wherein a rack gear is installed on the inner side of the armrest groove of the armrest frame support in the back-and-forth direction, and a pinion gear meshing with the rack gear and a position adjustment motor that operates based on control signals from the control unit of the massage device.

10. The massage device according to claim 1, further comprising:
side shields for shielding a space formed between the bottom of the arm massage unit and the side of the body massage unit when the arm massage unit rotates around the rotational shaft.

11. The massage device according to claim 8, wherein the plurality of side shields are folded or unfolded in multiple stages.

12. The massage device according to claim 1, wherein the rotation module comprises:
a motor installed in the body massage unit; and
a power transmission unit which transmits the rotational force of the motor to the rotational shaft.

13. The massage device according to claim 10, wherein the power transmission unit comprises:
a first worm gear connected to the motor to be rotatable;
a first worm wheel meshing with the first worm gear to receive rotational force;
a rotational force transmission shaft meshing with the first worm wheel to rotate together with the first worm wheel;
a second worm gear combined with the rotational force transmission shaft to rotate together with the rotational force transmission shaft; and,
a second worm wheel combined with the rotational shaft, meshing with the second worm gear to transmit the rotational force to the rotational shaft while rotating by receiving the rotational force from the second worm gear.

14. The massage device according to claim 1, further comprising:
a leg connection frame installed in the body massage unit;
a first leg massage unit rotatably connected to the leg connection frame and accommodating one leg of a user;
a second leg massage unit, spaced from one side of the first leg massage unit, connected to the leg connection frame to be rotated individually relative to the first leg massage unit, and accommodating the other leg of the user;
a connection module connecting the first leg massage unit and the second leg massage unit respectively to the leg connection frames; and
a leg rotation module providing rotational force to individually rotate the first leg massage unit and the second leg massage unit.

15. The massage device according to claim 14, wherein the connection module comprises:
a center support bracket provided on the leg connection frame, and supporting the inner sides of both the first leg massage unit and the second leg massage unit to be rotatable; and
a side support bracket provided on the leg connection frame, and supporting the outer sides of both the first leg massage unit and the second leg massage unit to be rotatable.
